(19) United States
(12) Patent Application Publication
(10) Pub. No.: US 2007/0276524 A1
(43) Pub. Date: Nov. 29, 2007

(54) Digital Sound Signal Processing Apparatus

(75) Inventor: Katsuo Tokuhara, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd, Daito-shi (JP)

(21) Appl. No.: 11/754,644

(22) Filed: May 29, 2007

(30) Foreign Application Priority Data
May 29, 2006 (JP) 2006-147970

(51) Int. Cl. G06F 17/00

(52) U.S. Cl. 700/94

(57) ABSTRACT

Disclosed is a digital sound signal processing apparatus which performs predetermined sound processing to a digital sound input signal of a predetermined format and is capable of outputting a digital or an analog sound signal from a plurality of output terminals, the apparatus including: delay units severally provided at preceding stages of the plurality of output terminals; a delay time setting unit to set delay times of the delay units respectively; and a sound output selection unit to select an output terminal that outputs the sound signal among the plurality of output terminals, wherein the delay time setting unit refers to sound output timing of a sound output apparatus connected to one of the output terminals as a standard to set the delay time of the delay unit of the other of the output terminals, when a plurality of output terminals are selected.

### BACKGROUND OF THE INVENTION

1. Field of the Invention

The present invention relates to a digital signal processing apparatus, and more particularly to a technique to eliminate asynchronization of sounds caused by performing signal processing of a coded digital sound signal in a plurality of different paths to output the sounds.

2. Description of Related Art

In recent years, video software using a digital versatile disk (digital video disk) (DVD) as a recording medium has adopted a sound standard such as Dolby digital system, which can reproduce sounds more three-dimensionally and powerfully in comparison with ordinary 2-channel stereo reproduction. In the Dolby digital system, a sound signal for a subwoofer (0.1 channel), whose voice band is limited to include only lower frequency, is recorded in a DVD in addition to 5-channel sound data composed of front 3 channels and rear 2 channels.

For example, in a home theater system built up by connecting an audio visual (AV) amplifier compatible with 5.1-channel surround sound system to a DVD player or the like, if a digital sound signal (for example, an Advanced Audio Coding (AAC) sound signal or a pulse code modulation (PCM) sound signal) is made to be output from a digital sound output terminal of the DVD player (for example, an optical digital signal output terminal) to the AV amplifier, highly realistic sounds of 5.1 channels recorded on a DVD are to be output from the speakers connected to the AV amplifier.

Moreover, if a digital sound signal is output after converting them into analog sound signals with the DVD player, it is also possible to output 2-channel sounds from the speakers built in a television receiver without using the above AV amplifier compatible with surround sound system.

Now, where a digital image signal and a digital sound signal that are recorded on a DVD is reproduced, the circuit for processing the digital image signal and the circuit for processing the digital sound signal have different configurations from each other. Consequently, it becomes problematic that the output timing of the demodulated image signal and that of the demodulated sound signal do not synchronize with each other.

Accordingly, a technique of preventing the asynchronization of the output timing of an image signal and that of a sound signal at the time of reproducing a digital video signal recorded on a DVD or the like was proposed (for example, Japanese Patent Application Laid-Open Publication No. 2005-184563 and Japanese Patent Application Laid-Open Publication No. 2004-088442). The above-described conventional technique is to prevent the asynchronization of the output timing of an image and that of a sound by delaying the output of the sound signal with respect to the output timing of an image signal at the time of reproducing a digital video signal recorded on a DVD or the like.

Incidentally, sounds are sometimes output through a plurality of different paths in a digital signal processing apparatus such as a DVD player. For example, there is a case where the DVD player outputs an analog sound signal to a television receiver and also outputs a digital sound signal to an AV amplifier compatible with a surround sound system.

In this case, the sounds from the speakers built in the television receiver and those from the 5.1 channel speakers connected to the AV amplifier sometimes do not synchronize because the times for processing input sound signals are different from each other. In particular, in the case where contents of a DVD are chiefly music (especially the case where sounds are output from many speakers through a plurality of AV amplifiers), the asynchronization between the images and the sounds is not a serious problem, but asynchronization between sounds output from the respective speakers causes an intense discomfort.

### SUMMARY OF THE INVENTION

It is a major object of the present invention to provide a digital sound signal processing apparatus which eliminates the asynchronization of sounds caused by outputting coded sound signals through a plurality of different paths (for example, an analog output, an optical digital output, and an HDMI output).

According to a first aspect of the invention, a digital sound signal processing apparatus which performs predetermined sound processing to a digital sound input signal of a predetermined format and is capable of outputting a digital or an analog sound signal from a plurality of output terminals, the apparatus comprises: delay units severally provided at preceding stages of the plurality of output terminals; a delay time setting unit to set delay times of the delay units respectively; and a sound output selection unit to select an output terminal that outputs the sound signal among the plurality of output terminals, wherein the delay time setting unit refers to sound output timing of a sound output apparatus connected to one of the output terminals as a standard to set the delay time of the delay unit provided at the preceding stage of the other of the output terminals, when a plurality of output terminals are selected by the sound output selection unit.

According to the invention, the digital sound signal processing apparatus is configured to include the delay unit provided at each of the preceding stage of the plurality of output terminals; the sound output selection unit selecting the output terminal outputting the sound signal among the plurality of output terminals; and the delay time setting unit setting the delay times of the respective delay units provided at the preceding stages of the other output terminals by referring to the sound output timing from the sound output apparatus connected to the one output terminal as the standard (delay time of 0) when the sound output selection unit selects the plurality of output terminals. Consequently, the sound output timings from the sound output apparatus (for example, a television receiver and an AV amplifier compatible with a surround-sound system) connected to the plurality of output terminals can be easily synchronized, and the asynchronization among the sound outputs can be eliminated.

Preferably, the digital sound signal processing apparatus may further comprise: a storage unit to store output terminal information about the output terminal selected by the sound output selection unit associated with delay time information about the delay times set by the delay time setting unit, wherein the delay time setting unit sets the delay times of the respective delay units based on the output terminal information and the delay time information, both pieces of information stored in the storage unit.

By doing so, the digital sound signal processing apparatus is configured to further include the storage unit to be able to record the output terminal information indicating which output terminal is selected by the sound output selection unit associated with the delay time information for the selection, wherein the delay time setting unit sets the delay times of the selected delay units based on the output terminal information and the delay time information, which are recorded in the storage unit. Consequently, delay times are automatically set according to a combination of the output terminals to perform sound output. Moreover, it can be avoided to uselessly perform the control processing of the delay times in the delay units corresponding to the output terminals that do not perform sound output, and the throughput of the apparatus can be consequently improved.

Preferably, a digital sound signal processing apparatus may further comprises: an input unit to receive an input, wherein the sound output selection unit selects the output terminal that outputs the sound signal among the plurality of output terminals based on an input signal from the input unit, and the delay time setting unit sets the delay times of the respective delay units based on the input signal.

By doing so, because the delay time setting unit is configured to set the delay times of the delay units based on the input signals from the input unit, a viewer can listen to the sounds output from the speakers or the like connected to the plurality of AV amplifiers to compare the sounds, and then the viewer can manually set the delay times. Consequently, even if the AV amplifiers connected to the output terminals are changed to different AV amplifiers having different digital signal processing performances, the optimum delay times can be set.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein;

FIG. 1 is a schematic configuration diagram of a digital television broadcast signal reception apparatus 100 according to the present embodiment;

FIG. 2 is a block diagram showing a principal part of a signal processing unit in the digital television broadcast signal reception apparatus 100; and

FIG. 3 is an explanatory diagram showing a relation between combinations of output terminals outputting sound signals and the delay times in delay buffers.

### DETAILED DESCRIPTION OF THE PREFERRED EMBODIMENTS

In the following, an embodiment to which a digital sound signal processing apparatus according to the present invention is applied will be described with reference to the attached drawings.

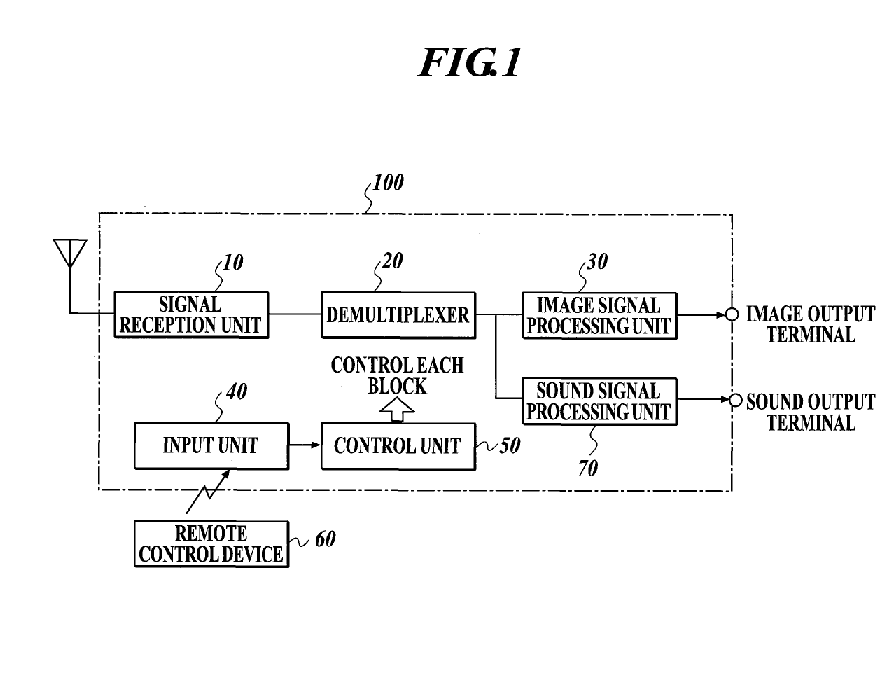

FIG. 1 is a schematic configuration diagram of a digital television broadcast signal reception apparatus (for example, a set top box) 100 according to the present embodiment.

The digital television broadcast signal reception apparatus 100 includes a signal reception unit 10, a demultiplexer 20, an image signal processing unit 30, a control unit 50, and a sound signal processing unit 70.

The control unit 50 is configured to include a CPU, a RAM, and a ROM. Various control programs are stored in the ROM, and the CPU uses the RAM as a work area while the CPU operates in accordance with the control programs in the ROM to control each block.

Moreover, a manipulated signal is input into the control unit 50 from an input unit 40 provided with a plurality of operation keys. Moreover, the input unit 40 has a remote control signal reception unit (not shown) to be able to receive a manipulated signal (for example, an infrared signal) from a remote control device 60, and is configured so that a manipulated signal can be input from the remote control device 60 into the control unit 50.

In the digital television broadcast signal reception apparatus 100, a digital television broadcast signal received with the signal reception unit 10 through an antenna is separated to a digital image signal and a digital sound signal in the demultiplexer 20. The separated digital image signal and the digital sound signal are converted into predetermined format signals in the image signal processing unit 30 and in the sound signal processing unit 70, respectively, and are output from an image output terminal and a sound output terminal, respectively.

Incidentally, the digital television broadcast signal reception apparatus 100 of the present embodiment is configured to be able to process TS signals including a digital image sound signal defined in the Moving Picture Experts Group-2 (MPEG-2). Moreover, the sound signal processing unit 70 is configured to be able to process an AAC sound signal and a PCM sound signal as the digital sound signals.

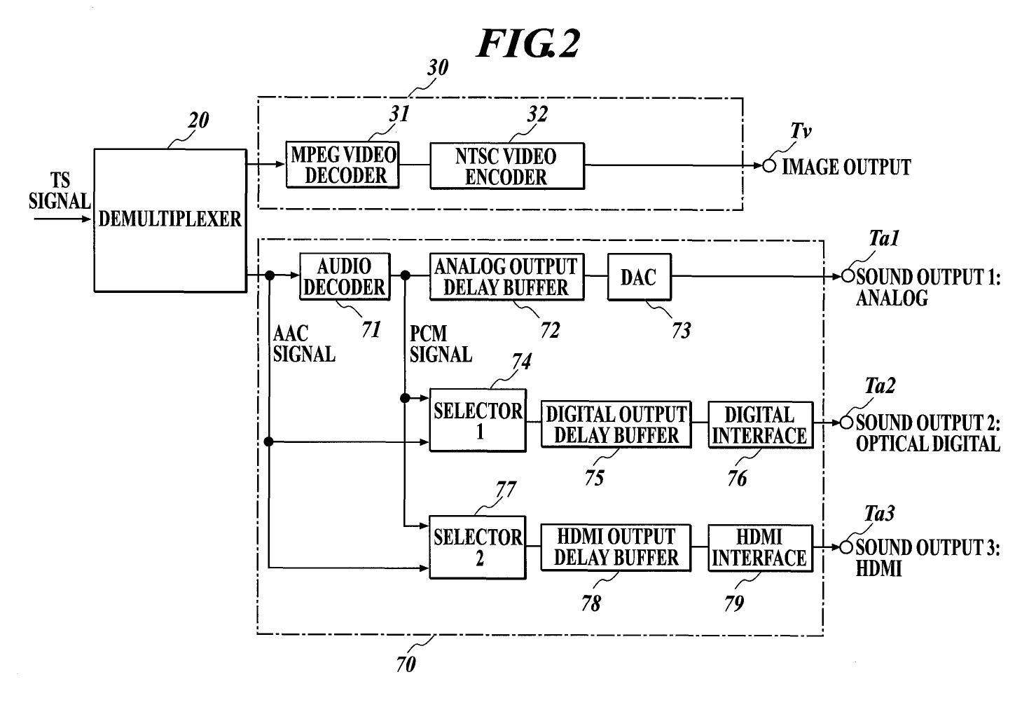

FIG. 2 is a block diagram of the principal part of a signal processing unit in the digital television broadcast signal reception apparatus 100. The digital television broadcast signal reception apparatus 100 of the present embodiment includes one analog sound signal output terminal Ta1 and two digital sound signal output terminals (optical digital, HDMI) Ta2 and Ta3 as the sound output terminals.

The image signal processing unit 30 includes an MPEG video decoder 31 and an NTSC video encoder 32. The MPEG video decoder 31 performs decoding processing to a coded digital image signal input from the demultiplexer 20. The NTSC video encoder 32 converts a decoded digital image signal into an image signal of the NTSC system, and outputs the converted image signal from an image output terminal Tv to an image output apparatus, such as a plasma display panel (PDP), a cathode ray tube (CRT), and a liquid crystal display (LCD). Incidentally, in the case where the image output apparatus can process the digital image signal, the image signal processing unit 30 can be configured to output the digital image signal.

The sound signal processing unit 70 includes an audio decoder 71, an analog output delay buffer 72, a digital/analog converter 73, a first selector 74, a digital output delay buffer 75, a digital interface 76, a second selector 77, an HDMI output delay buffer 78, and an HDMI interface 79.

The audio decoder 71 performs digital sound processing, such as decoding processing and surround-sound processing, to a coded digital sound signal input from the demultiplexer 20. For example, if an input digital sound signal is coded by the AAC, then the audio decoder 71 performs the decoding processing of an AAC sound, and if the input digital sound signal is modulated by the PCM, then the audio decoder 71 performs the generation processing of a PCM signal. Incidentally, the digital sound processing in the audio decoder 71 is the processing performed to a digitized sound signal, and is not limited to those pieces of processing.

The analog output delay buffer 72 as a delay unit receives the input of a sound signal that has been subjected to the digital sound processing by the audio decoder 71, and delays the input digital sound signal by a predetermined delay time to output the delayed signal. The delay time, i.e. a delay time, is set by the control unit (CPU) 50 as a delay time setting unit.

The D/A converter (DAC) 73 receives the input of a digital sound signal delayed by the analog output delay buffer 72, and converts the input digital sound signal into an analog sound signal. The analog sound signal converted by the D/A converter 73 is output to a television receiver as a sound output apparatus from the analog sound signal output terminal Ta1. The sounds are then output from the speakers built in the television receiver.

The first selector 74 is configured to be able to receive the inputs of an AAC signal from the demultiplexer 20 and a PCM signal from the audio decoder 71, and to automatically select any of the digital sound signals according to the sound mode of a digital sound signal input from the demultiplexer 20 to output the selected digital sound signal. The sound modes of the input digital sound signals are discriminated by the control unit (CPU) 50 here. For example, the control unit (CPU) 50 can distinguish between the sound signal of the AAC system and the sound signal of the PCM system of the sound signal input from the demultiplexer 20 based on the information obtained from a TS signal.

The digital output delay buffer 75 as the delay unit receives the input of the digital sound signal selected by the selector 74, and delays the input digital sound signal (the AAC signal or the PCM signal) by the predetermined delay time to output the delayed sound signal. The delay time at this time, that is, the delay time, is set by the control unit (CPU) 50 as the delay time setting unit.

The digital sound signal delayed by the digital output delay buffer 75 is output from the digital sound signal output terminal (for example, an optical digital signal output terminal) Ta2 to an AV amplifier compatible with the surround-sound system as the sound output apparatus through the digital interface 76. The output digital sound signal is then subjected to digital sound processing by the AV amplifier, and is output from, for example, the 5.1 channel speakers connected to the AV amplifier.

The second selector 77 is configured to be able to receive the inputs of an AAC signal from the demultiplexer 20 and a PCM signal from the audio decoder 71, and to automatically select any of the digital sound signals according to the sound mode of a digital sound signal input from the demultiplexer 20 to output the selected digital sound signal. For example, if the digital sound signal input from the demultiplexer 20 is the sound signal of the AAC system, then the second selector 77 outputs the AAC signal, and if the digital sound signal is the sound signal of the PCM system, then the second selector 77 outputs the PCM signal that has been subjected to the digital sound processing by the audio decoder 71. Moreover, the selector 77 is, for example, controlled by the control unit (CPU) 50.

The high-definition multimedia interface (HDMI) output delay buffer 78 as the delay unit receives the input of the digital sound signal selected by the selector 77, and delays the input digital sound signal (the AAC signal or the PCM signal) by the predetermined delay time to output the delayed sound signal. The delay time at this time, that is, the delay time, is set by the control unit (CPU) 50 as the delay time setting unit.

The digital sound signal delayed by the HDMI output delay buffer 78 is output from the HDMI signal output terminal Ta3 to a digital television receiver compatible with the HDMI as the sound output apparatus through the HDMI interface 79. The output digital sound signal is then subjected to digital sound processing by the digital television receiver, and is output from the built-in speakers.

The coded digital sound signal is subjected to the signal processing in the plurality of different paths in the digital television broadcast signal reception apparatus 100 having the configuration mentioned above, and asynchronization of the timings when the sounds are actually output from the speakers consequently arise. The present embodiment is accordingly configured so that the control unit 50 as the delay time setting unit may suitably set the delay times of the analog output delay buffer 72, the digital output delay buffer 75, and the HDMI output delay buffer 78.

Moreover, the control unit 50 as a sound output selection unit selects an output terminal to output a sound signal based on an signal input from the input unit 40 caused by an input operation by a viewer. If sound signals are output from a plurality of output terminals, delay controls are executed in predetermined delay buffers.

For example, the following case is examined: the timing of outputting sounds from the built-in speakers of the television receiver connected to the analog sound signal output terminal Ta1 is denoted by T1; the timing of outputting sounds from the speakers of the AV amplifier connected to the optical digital signal output terminal Ta2 is denoted by T2 (<T1); and the timing of outputting sounds from the built-in speakers of the digital television receiver connected to the HDMI signal output terminal Ta3 is denoted by T3 (<T2). That is, the case is the one in which the same sound signal is output from the built-in speakers of the digital television receiver, the speakers of the AV amplifier, and the built-in speakers of the television receiver.

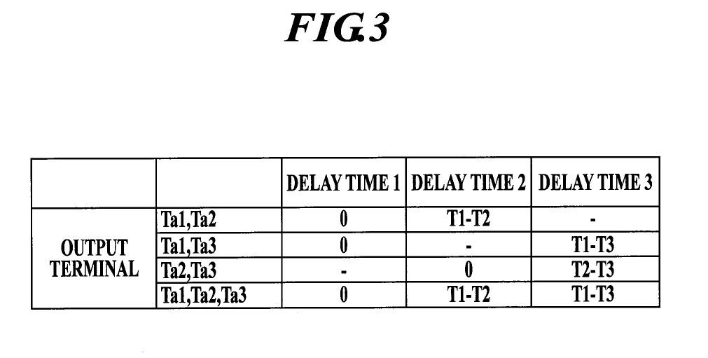

In such a case, as shown FIG. 3, the latest output timing is set as a standard, and the output timings of the other sound signals are delayed based on the latest output timing to make it possible to conform the timings of all of the actual sound outputs from the speakers. For example, a viewer can set the delay time of each of the delay buffers by operating the input unit 40. At this time, the viewer also sets the output timing of the sound signal that is used as the standard.

FIG. 3 is an explanatory diagram showing the relations between the combinations of the output terminals from which the sound signal is output and the delay times 1, 2, and 3 of the analog output delay buffer 72, the digital output delay buffer 75, and the HDMI output delay buffer 78.

That is, if sounds are output from the analog sound signal output terminal Ta1 and the optical digital signal output terminal Ta2, the sound output timing T1 from the speakers of the television receiver connected to the analog sound signal output terminal Ta1 is set as the standard (that is, the delay time 1 of the analog output delay buffer 72 is set to 0), and the delay time 2 of the digital output delay buffer 75 may be set to T1-T2. If the viewer sets the sound output timing T2 from the speakers of the AV amplifier connected to the optical digital signal output terminal Ta2 as the standard and sets the delay time 1 of the analog output delay buffer 1, the asynchronization of the output sounds become larger. Consequently, it can be easily known which sound output timing should be set as the standard. Incidentally, because the sound output of the HDMI signal output terminal Ta3 is unavailable at this time, the delay control by the HDMI output delay buffer 78 is not performed.

Moreover, if sounds are output from the analog sound signal output terminal Ta1 and the HDMI signal output terminal Ta3, the sound output timing T1 from the speakers of the television receiver connected to the analog sound signal output terminal Ta1 is set as the standard, and the delay time 3 of the HDMI output delay buffer 78 may be set to T1-T3. Because the sound output of the optical digital signal output terminal Ta2 is unavailable at this time, the delay control by the digital output delay buffer 75 is not performed.

Moreover, if sounds are output from the optical digital signal output terminal Ta2 and the HDMI signal output terminal Ta3, the sound output timing T2 from the speakers of the AV amplifier connected to the optical digital signal output terminal Ta2 is set as the standard, and the delay time 3 of the HDMI output delay buffer 78 may be set to T2-T3. Because the sound output of the analog sound signal output terminal Ta1 is unavailable at this time, the delay control by the analog output delay buffer 72 is not performed.

Moreover, if sounds are output from the analog sound signal output terminal Ta1, the optical digital signal output terminal Ta2 and the HDMI signal output terminal Ta3, the sound output timing T1 from the speakers of the television receiver connected to the analog sound signal output terminal Ta1 is set as the standard, and the delay time 2 of the digital output delay buffer 75 and the delay time 3 of the HDMI output delay buffer 78 may be set to T1-T2 and T2-T3, respectively.

Incidentally, if only one output terminal is selected by the sound output selection unit, no asynchronization arise among output sounds. Accordingly, the delay processing is not performed. However, if an output image and an output sound are synchronized with each other, predetermined delay processing must be performed.

As described above, the digital television broadcast signal reception apparatus 100 of the present embodiment provides the delay buffers 72, 75, and 78d at the preceding stages of the plurality of sound signal output terminals Ta1, Ta2, and Ta3, respectively, and if a plurality of output terminals are selected by the sound output selection unit, then the sound output timing of the sound output apparatus connected to one output terminal is set to a standard (delay time of 0) with the delay time setting unit to set the delay times of the delay units provided to the preceding stages of the other output terminals. Consequently, the sound output timings of the sound output apparatus (for example, the built-in speakers of the television receiver and the 5.1 channel speakers connected to the AV amplifier compatible with the surround-sound system) connected to the plurality of sound signal output terminals Ta1, Ta2, and Ta3 can be easily synchronized, and the asynchronization among the sound outputs can be eliminated.

Moreover, because the delay time setting unit is configured to set the delay times of the delay units based on an input signal from the input unit, a viewer can listen to the sounds output from the plurality of speakers connected to the AV amplifier and compare them, and then the viewer can manually set delay times. Consequently, even if the digital signal processing performances of sound processing apparatus such as the AV amplifier connected to the output terminals are different from each other, the optimum delay times can be set. Moreover, if the sound output apparatus connected to the output terminals are changed, it is possible to easily cope with the changes.

Although the present invention made by the inventor has been concretely described based on the embodiment above, the present invention is not limited to the embodiment, but can be changed within the range without departing the scope of the present invention.

For example, the embodiment mentioned above is configured so that a viewer operates the input unit 40 to set the delay time of each of the delay buffers, the digital sound signal processing apparatus may be configured so that the storage unit can store the output terminal information indicating which output terminal is selected by the sound output selection unit in the state of being associated with the delay time information at that time (see FIG. 3). That is, because the frequency of the changes of the sound output apparatus connected to the output terminals is very low, the delay time of each of the delay buffers may be once set to use the set delay time afterward. Moreover, when a viewer uses the input unit 40 to set the delay time of each of the delay buffers, it is desirable to record the state in the storage unit to update the record thereof.

Moreover, although the digital television broadcast signal reception apparatus is cited to be described as an example of the digital sound signal processing apparatus in the embodiment mentioned above, the digital sound signal processing apparatus is not to the digital television broadcast signal reception apparatus, but may be a reproduction apparatus, such as a DVD player, for reproducing MPEG-TS signals, or computer equipment.

Moreover, the digital sound signals that the digital sound signal processing apparatus can process are not limited to the AAC sound signals and the PCM sound signals, but the digital sound signals of the other formats such as the AC-3, the WAV, the AIFF, the MP3, the WMA, and the ATRAC3 can be also applied.

Moreover, in the embodiment mentioned above, the synchronization of the image output and the sound outputs can be also easily realized by applying a conventional technology.

The entire disclosure of Japanese Patent Application No. 2006-147971 filed on May 29, 2006, including description, claims, drawings and summary are incorporated herein by reference in its entirety.

What is claimed is:

1. A digital sound signal processing apparatus which performs predetermined sound processing to a digital sound input signal of a predetermined format and is capable of outputting a digital or an analog sound signal from a plurality of output terminals, the apparatus comprising:
delay units severally provided at preceding stages of the plurality of output terminals;
a delay time setting unit to set delay times of the delay units respectively;
a sound output selection unit to select an output terminal that outputs the sound signal among the plurality of output terminals;
a storage unit to store output terminal information about the output terminal selected by the sound output selection unit associated with delay time information about the delay times set by the delay time setting unit; and
an input unit to receive an input, wherein
the sound output selection unit selects the output terminal that outputs the sound signal among the plurality of output terminals based on an input signal from the input unit, and
the delay time setting unit sets the delay times of the respective delay units based on the output terminal information and the delay time information, both pieces of information stored in the storage unit, and sets the delay times of the respective delay units based on the input signal when the input unit receives the input.

2. A digital sound signal processing apparatus which performs predetermined sound processing to a digital sound input signal of a predetermined format and is capable of outputting a digital or an analog sound signal from a plurality of output terminals, the apparatus comprising:
delay units severally provided at preceding stages of the plurality of output terminals;
a delay time setting unit to set delay times of the delay units respectively; and
a sound output selection unit to select an output terminal that outputs the sound signal among the plurality of output terminals, wherein
the delay time setting unit refers to sound output timing of a sound output apparatus connected to one of the output terminals as a standard to set the delay time of the delay unit provided at the preceding stage of the other of the output terminals, when a plurality of output terminals are selected by the sound output selection unit.

3. The digital sound signal processing apparatus according to claim 2, further comprising:
a storage unit to store output terminal information about the output terminal selected by the sound output selection unit associated with delay time information about the delay times set by the delay time setting unit, wherein
the delay time setting unit sets the delay times of the respective delay units based on the output terminal information and the delay time information, both pieces of information stored in the storage unit.

4. The digital sound signal processing apparatus according to claim 2, further comprising:
an input unit to receive an input, wherein
the sound output selection unit selects the output terminal that outputs the sound signal among the plurality of output terminals based on an input signal from the input unit, and
the delay time setting unit sets the delay times of the respective delay units based on the input signal.
